(19) United States
(12) Patent Application Publication
(10) Pub. No.: US 2015/0183582 A1
(43) Pub. Date: Jul. 2, 2015

(54) Multi-Level Deck Recycling Chute

(71) Applicant: Robert Sambuca, Miami, FL (US)

(72) Inventor: Robert Sambuca, Miami, FL (US)

(21) Appl. No.: 14/588,200

(22) Filed: Dec. 31, 2014

Related U.S. Application Data
(60) Provisional application No. 61/922,392, filed on Dec. 31, 2013.

(51) Int. Cl. B65G 11/02

(52) U.S. Cl. CPC B65G 11/023

(57) ABSTRACT

The present invention provides a recycling chute that provides multi-level access to a recycling container to throw away bottles and cans from a raised outdoor deck or multi-level deck to the ground-level. The recycling chute includes piping having a first end and a second end and removably attaches to the railings and support beams of a raised deck or multi-level deck using fasteners. The first end includes an inlet port that is configured to receive bottles and cans. The piping further includes additional access points, using Y-couplers at each additional floor of the deck. The piping extends substantially from the inlet port on the uppermost deck to an outlet port at the second end of the piping on the ground-level. The piping may further includes lining that is designed to attenuate the sound of bottles and cans passing through the pipe.

### CROSS REFERENCE TO RELATED APPLICATION

This application claims the benefit of U.S. Provisional Application No. 61/922,392 filed on Dec. 31, 2013. The above identified patent application is herein incorporated by reference in its entirety to provide continuity of disclosure.

### BACKGROUND OF THE INVENTION

### Field of the Invention

The present invention relates to recycling and garbage disposal. More specifically, the present invention pertains to an improved recycling chute for multi-level decks or raised decks. The present invention includes piping having an inlet port and an inlet port extending downwardly from the uppermost level of a deck to an outlet port substantially on the ground level. The piping extends along the railings and support beams of a multi-level deck or raised deck and removably fastens thereon. The piping may further include additional access points on lower levels of a multi-level deck through Y-couplers.

The arrival of warm weather usually marks a new season of outdoor fun and entertaining. With the summer months, many people are looking to upgrade their outdoor living space by upgrading their existing decks, landscaping their yards, purchasing outdoor furniture and accessories, and updating their grilling and cooking areas. Hosting a party and entertaining guests on an outdoor deck or patio is a way to bring people together in one's home and encourage them to enjoy the splendor of warmer weather. Not to mention a great way to show off new or upgraded decks and outdoor living spaces.

However, being the host of a party means the outdoor deck needs to be cleaned up after the guests are gone. Sometimes, such a task is daunting and a deterrence for even hosting an event. There are many tips to hosting a great get-together that will lighten the post-celebration clean-up load, such as using disposable and recyclable items. In terms of drinks, stocking up on canned and bottled drinks could significant lessen the load on washing cups and glasses. Yet, buying cans and bottled drinks stem its own set of problems. Inevitably cans will be left all over the deck as there is no clear means to recycling. Or if decks are above ground level, carrying cans or bottles to the ground level can be a troublesome clean-up. Sometimes, if the deck is above ground level, the backyard may be littered with cans or bottles as guests have thrown their empty drinks over the balcony.

The present invention, however should alleviate and solve the problems with recycling cans and bottles on a deck that is above the ground level. The present invention provides a recycling chute that provides a convenient way to recycle cans and bottles from an outdoor deck to the ground level that can greatly reduce mess. The recycling chute leads to a ground level recycling bin and decreases the number of recycling bags, plastic production and waste at home. The recycling chute comprises a piping having a first end and a second end, wherein the first end further comprises an inlet port and the second end further comprises an outlet port. The recycling chute further includes additional access points, using Y-couplers, at each floor of a multi-level deck. The length of the piping is substantially sized to accommodate for the height of the uppermost level of a multi-level deck to the ground level having a recycling container. The piping is substantially sized to allow for large bottles to flow therethrough. The piping may also further include a lining that is designed to mute the sound of bottles and cans passing through the piping.

### DESCRIPTION OF THE PRIOR ART

Devices have been disclosed in the prior art that relate to recycling and trash disposal. These include devices that have been patented and published in patent application publications. These devices disclose waste chutes that are embedded in the wall of a tall apartment building. Some devices include a selection device for use by the user to select the type of trash or recyclable material to be discarded. Other devices provide multiple chutes with respective inlet ports for each type of trash. These devices, however, do not disclose a trash chute that is fastened to the railing of a raised deck or a multiple-floored deck. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,422,144 is a system to separate and store trash in a multi-floor building includes a waste chute with at least one intake door located on a floor of the building. The Importico device further discloses a login device that identifies a user and a selection device that selects the type of trash to be discarded. There are at receptacles for the according types of trash. A diverter assembly diverts trash placed into the chute to one of the receptacles. The Importico device further discloses a scale that measures the weight in each receptacle. However, the Importico device does not disclose a device that is removably fastened to the railing of a raised deck or multiple-floor deck.

Similarly, U.S. Pat. No. 5,551,576 to Importico is also a system to separate and store trash which has been segregated into various types of trash for a multiple-floor building. The Importico device discloses a vertical waste chute with at least one access door to the chute located at each floor of the building. The chute has an upper and lower portion and two paths therethrough. The first path permits vertical disposal of the trash and the second path is angle to the first to permit designated trash to follow a different pathway for disposal. The Importico device further discloses a diverter located adjacent to the lower portion of the chute to divert the path of trash to a particular category of trash receptacles. Further, there is a replacing mechanism that includes a sensor to alert when a certain receptacle is full. However, the Importico device does not provide a recycling chute sized to allow large bottles to flow therethrough.

U.S. Pat. No. 2,177,328 to Lorenzo is a garbage disposal device that discloses a chute embedded into the wall of a structure in an upright position, an inlet inclined downwardly, an outlet pipe on the lower end of the chute, a container to receive trash from the outlet pipe, and a container lid mounted on the pipe. However, the Lorenzo device does not include fasteners that allow a recycling chute to be removably fastened to the railings of a multi-level deck

U.S. Pat. No. 3,273,840 to Olov discloses a carriage adapted to be shifted from a position below a garbage chute, one or more additional garbage containers arranged in connection with the carriage, and a holding device provided adjacent the garbage chute so that when the carriage is displaced the additional container connected to the carriage will unfold below the garbage chute. Therefore, the Olov device is unrelated and does not disclose a recycling chute removably fastened to a multi-level deck.

U.S. Pat. No. 5,806,759 to Axisa discloses a waste disposal apparatus that is built-in to the wall of a building and sorts recyclable and non-recyclable waste within the building to be dispensed to garbage bins outside of the building. The Axisa device discloses a plurality of modular chutes that are embedded into the wall with inlet ports for each chute which are substantially co-planar with the wall. Inlet ports have doors that open and close the inlet ports. The Axisa device is also not directed to a device for recycling disposal that is removably fastened to the railing of an outdoor raised deck or multi-level deck.

Finally, U.S. Pat. No. 5,706,971 to Taylor discloses a trash lid that has interchangeable insert plates to convert the lid for a variety of different uses. The Taylor device discloses a trash bin lid that has a plurality of interchangeable insert plates, each being separately mountable on the lid opening, where one insert plate is adapted to completely close the lid opening and another insert plate which is adapted to only partially close the lid opening. However, the Taylor device is also not directed to a chute that is fastened to the railing of a raised deck or a multi-level deck.

The devices disclosed in the prior art have several known drawbacks. These devices disclose waste chutes that are embedded in the wall of a tall apartment building. Some of these devices include a selection device for use by the user to select the type of trash or recyclable material to be discarded. Other devices use multiple chutes with respective inlet ports for each type of trash. However, these devices are limited as they are not directed to a recycling chute removably fastened to the railing of an outdoor raised deck or multi-floored deck. The present invention overcomes these limitations by disclosing recycling chute that is secured to the railing to an outdoor raised deck or multi-floored deck that is adapted to be a convenient way to dispose cans and bottles on every floor of a deck into a recycling bin on the ground floor.

The present invention provides a recycling chute that allows access from a multi-level deck or a raised deck. The recycling chute includes piping that has an inlet port and an outlet port. The piping also includes additional access points through Y-couplers. In addition, the piping may further comprise lining that is configured to mute the sound of bottles and cans passing therethrough. It is therefore submitted that the present invention is substantially divergent in design elements from the prior art, and consequently it is clear that there is a need in the art for an improvement to recycling and trash disposal In this regard, the instant invention substantially fulfills these needs.

### SUMMARY OF THE INVENTION

In view of the foregoing disadvantages inherent in the known types of trash chutes now present in the prior art, the present invention provides a new and improved recycling chute that is removably fastened to the railing of a raised deck or multi-floored deck for disposal of cans and bottles into a recycling receptacle.

It is therefore an object of the invention to provide a new and improved multi-level deck recycling chute that has all of the advantages of the prior art and none of the disadvantages.

Another object of the present invention is to provide a new and improved multi-level deck recycling chute that comprises piping having a first end and a second end, wherein the first end includes an inlet port and the second end includes an outlet port.

Another object of the present invention is to provide a new and improved multi-level deck recycling chute that provides additional access points on lower levels of a multi-level deck through Y-couplers.

Yet another object of the present invention is to provide a new and improved multi-level deck recycling chute that allows for bottles and cans to be recycled therethrough to a recycling receptacle on the ground floor.

Still yet another object of the present invention is to provide a new and improved multi-level deck recycling chute that provides a recycling chute removably fastened to a multi-level deck or raised deck through fasteners that removably fasten to the railings or stakes of the multi-level deck or raised deck.

An object of the present invention is to provide a new and improved multi-level deck recycling chute that further includes a lining that muffles the sound of bottles and cans passing therethrough.

Still yet another object of the present invention is to provide a new and improved multi-level deck recycling chute wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a side perspective of the preferred embodiment for the present invention as removably fastened to a raised deck.

FIG. 2 shows a side cross-sectional view of the present invention.

FIG. 3 shows a side perspective of the inlet port of the preferred embodiment for a raised deck of the present invention.

FIG. 4 shows a side perspective view of an alternative embodiment for a multi-level deck of the present invention.

### DETAILED DESCRIPTION OF THE INVENTION

References are made herein to the attached drawings. Like reference numerals are used throughout the drawings to depict like or similar elements of the multi-level deck recycling chute. For the purposes of presenting a brief and clear description of the present invention, the preferred embodiment will be discussed as fastened on a multi-level deck or a raised deck. The figures are intended for representative purposes only and should not be considered to be limiting in any respect.

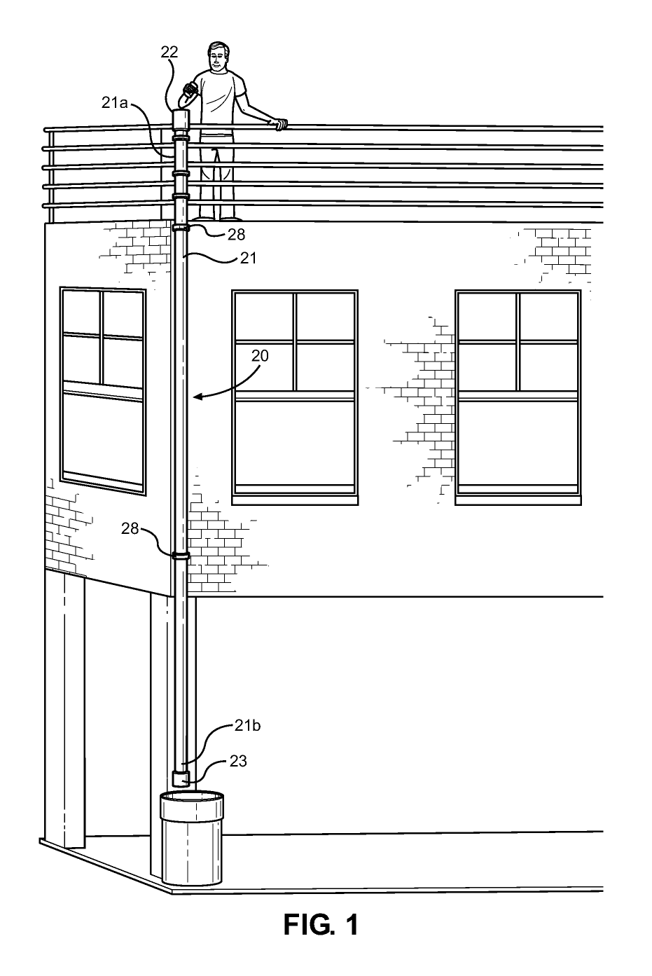

Referring now to FIG. 1, there is shown a side perspective view of the recycling chute 20 as removably attached to a raised deck. The recycling chute 20 is a cylindrical tubular construction comprising piping 21 having an open first end 21A and an open second end 21B. The first end 21 further comprises an inlet port 22, while the second end 21B further comprises an outlet port 23. The piping 21 is designed to be removably fastened in an upright position along the railing and stakes of a raised deck through a plurality of fasteners 28. Preferably, the plurality of fasteners 28 are evenly spaced apart along the length of the piping 21. The piping 21 also further include a lining that is designed to mute the sound of items passing therethrough.

The inlet port 22 is designed to receive bottles and cans, wherein the bottles and cans pass through the piping 21 to the outlet port, which is connected to a recycling receptacle. The piping 21 is preferably constructed of polyvinyl chloride. However, without limitation, other embodiments of the piping 21 are constructed from other suitable noncorrosive material, such as other plastics.

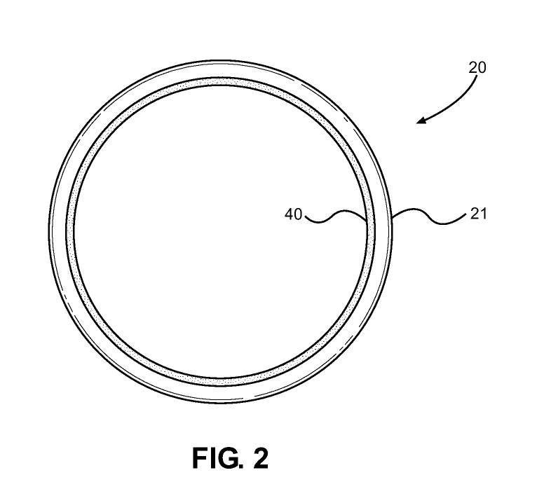

Referring, now to FIG. 2, there is shown a side cross-sectional view of the piping 21. The piping 21 further comprises an inner lining 40 that is designed to line the entirety of the interior surface of the piping 21. Preferably the inner lining 40 is constructed of acrylonitrile butadiene styrene, however, other embodiments construct the inner lining 40 from other suitable material, such as other plastics. The inner lining 40 is configured to muffle the sound of passing bottles and cans therethrough, while also preventing rotting, rusting, foul odor, and the collection of waste.

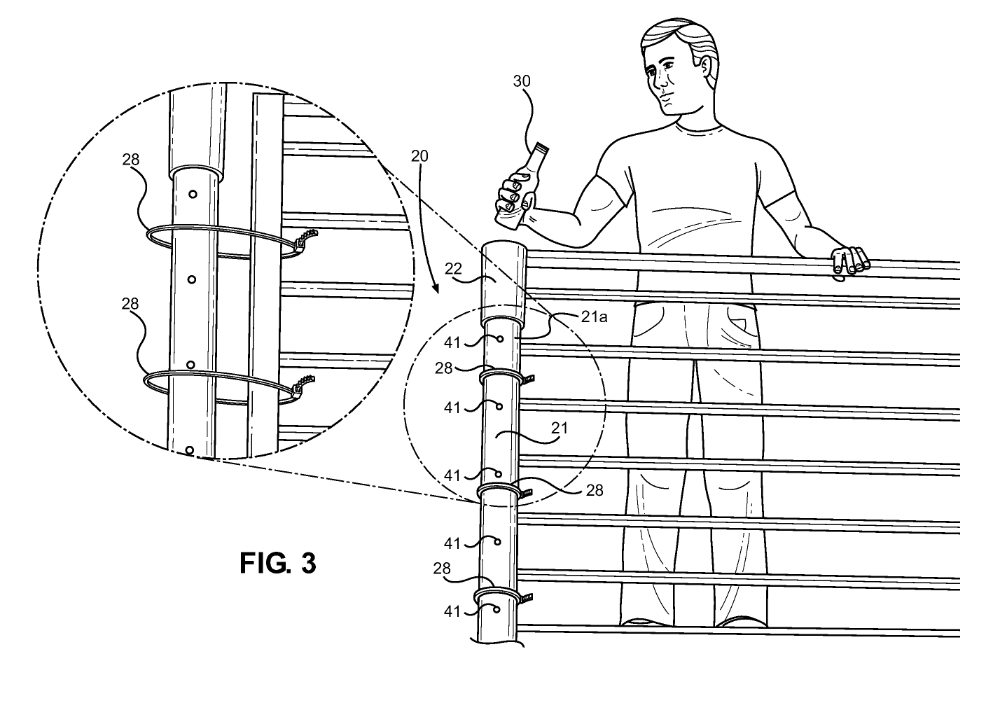

Referring now to FIG. 3, there is shown a side perspective of the open first end 21A of the recycling chute 20. The recycling chute is a hollow tubular construction comprising piping 21 having an open first end 21A and an open second 21B. The open first end further comprises an inlet port 22 that is designed to receive cans and bottles 30 to pass through the piping 21 to a recycling receptacle on the ground floor. The inlet port 22 is substantially the same circumference of the piping 21, wherein the piping 21 is sized to allow bottles 30 to pass therethrough. Some embodiments of recycling chute 20 may allow larger bottles, such as a two-liter soda bottle, to be received and passed therethrough. In addition, the inlet port 22 is specifically sized to prevent multiple cans or bottles 30 from passing therethrough. As can be readily recognized, the sizing of the inlet port 22 is particularly advantageous to prevent clogging and lodging of multiple cans or bottles 30 therein. Therefore, the inlet port 22 only allows for cans or bottles 30 to be received one at a time.

Piping 21 also further comprises a plurality of apertures 41 that are position along the piping 21. The apertures are designed to allow air therethrough to prevent molding, rotting, or foul odor from remnant liquid dripped on the piping 21. The piping 21 is removably fastened to the railing of a raised deck through fasteners 28. Fasteners 28 are preferably zip tie fasteners; however, other embodiments include clamp and other permanent fittings that would support the piping 21 from its exterior circumference. The fasteners 28 are configured to hold the piping 21 in an upright position against the railing of a raised deck to prevent the piping 21 from falling and possibly causing harm to people standing below the piping 21.

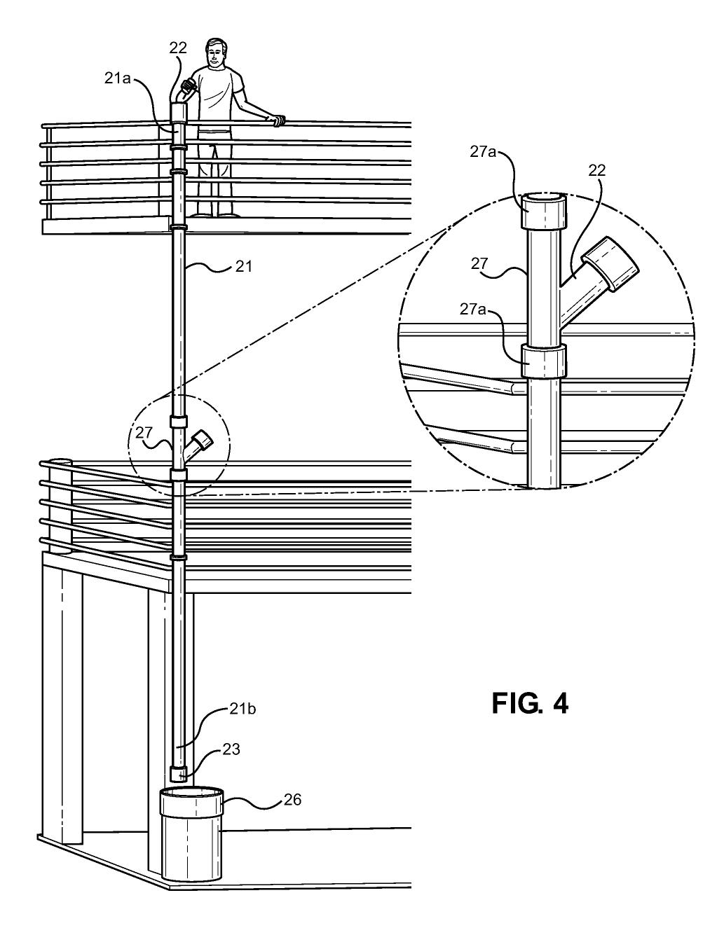

Referring now to FIG. 4, there is shown a side perspective of an alternative preferred embodiment as fastened on a multi-level deck. The recycling chute 20 is a hollow tubular construction having a first end 21A with an inlet port 22 and a second end 21B with an outlet port 23. The piping 21 is removably fastened to the railing or stakes of a multi-level deck in an upright position. A user inserts a bottle or can in the inlet port 22, which then travels downwards towards the outlet port 23. The outlet port 23 is positioned over a recycling receptacle 26 to reduce the time needed to clean up. The outlet port 23 is circumferentially sized substantially the same as inlet port 22, wherein one can or bottle is allowed therethrough.

In this alternative preferred embodiment, piping 21 also comprises at least one Y-coupler 27 that provides alternative access points to the recycling chute 20 on different floors of a multi-level deck. Y-coupler 27 is substantially in a Y-shape with a pair of connecting ends 27A designed to connect piping 21 together and maintain consistent flow therethrough. The Y-coupler 27 further includes an inlet port 22 that is extended outwardly in relation to the pair of connecting ends 27A. In this way, the inlet port 22 of the Y-coupler 27 is designed to allow a user to recycle cans or bottles from a lower floor of a multi-level deck through the chute 20, instead of having to climb to the uppermost level of the deck. In other embodiments, piping 21 is equipped with a plurality of Y-couplers 27 to match the number of levels of a multi-level deck. Preferably, the Y-coupler 27 is constructed of the same suitable material as piping 21, however, other embodiments are alternatively composed of other suitable plastics. In addition, although the Y-coupler 27 is preferable, other embodiments use other types of couplers or connectors to provide for additional access points.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multi-level deck recycling chute for cans and bottles, comprising:
a piping having a hollow tubular construction, an open first end, an open second end, a plurality of apertures, and a plurality of fasteners;
said open first end having an inlet port;
wherein said inlet port is designed to receive a can or bottle therethrough on an uppermost level of a multi-level deck;
said open second end having an outlet port;
wherein said outlet port is designed to connect to a receptacle on a lower floor;
said plurality of apertures located along the length of said piping;
wherein said apertures being disposed along said piping and designed to allow air to flow from an interior of said piping;
said piping having a length and said fasteners being disposed along said length, whereby said fasteners are designed to fasten said piping in an upright position to said multi-level deck.

2. The multi-level deck recycling chute for cans and bottles of claim 1, wherein the piping further comprising a plurality of Y-couplers designed to provide additional access points along said multi-level deck.

3. The multi-level deck recycling chute for cans and bottles of claim 2, wherein:
each of said Y-couplers comprises a pair of connecting ends that maintain a linear configuration of said piping, and an alternative inlet port;
said alternative inlet port being configured to receive said can or bottle therethrough to enter said piping.

4. The multi-level deck recycling chute for cans and bottles of claim 1, wherein said inlet port is designed to substantially receive one can or bottle at a time.

5. The multi-level deck recycling chute for cans and bottles of claim 1, wherein said outlet port is designed to substantially receive one can or bottle at a time.

6. The multi-level deck recycling chute for cans and bottles of claim 1, wherein said piping has an interior diameter sized to receive one can or bottle at a time.

7. The multi-level deck recycling chute for cans and bottles of claim 1, wherein said piping further comprises an inner lining;
wherein said inner lining is designed to muffle sounds from said can or bottle passing through said piping.
